(19) United States
(12) Patent Application Publication
(10) Pub. No.: US 2013/0097176 A1
(43) Pub. Date: Apr. 18, 2013

(54) METHOD AND SYSTEM FOR DATA MINING OF SOCIAL MEDIA TO DETERMINE AN EMOTIONAL IMPACT VALUE TO MEDIA CONTENT

(71) Applicants: Aslam Khader, Beaverton, OR (US); Larry Alan Westerman, Portland, OR (US)

(72) Inventors: Aslam Khader, Beaverton, OR (US); Larry Alan Westerman, Portland, OR (US)

(73) Assignee: ENSEQUENCE, INC., Portland, OR (US)

(21) Appl. No.: 13/271,990

(22) Filed: Oct. 12, 2011

(51) Int. Cl. G06F 17/30

(52) U.S. Cl. 707/748; 707/E17.009

(57) ABSTRACT

A computer system provides access to a corpus of social media content; extracts from the corpus of social media content one or more ratings of an item of media content; identifies the author of each of the one or more ratings; analyzes the content of each of the one or more ratings of an item of media content and assigns a value to each of the one or more ratings; analyzes the corpus of social media content and assigns an impact coefficient to the author of each of the one or more ratings; aggregates the values of the one or more ratings, weighted by the assigned impact coefficients of the author of each of the one or more ratings, and determines therefrom an aggregated value; and based on the aggregated value, assigns an emotional impact value to the item of media content.

### FIELD OF THE INVENTION

This invention relates generally to consumer affinity for media content, and more specifically to methods and systems that utilize social media content to quantify the emotional impact of media content.

### BACKGROUND OF THE INVENTION

Advertisement is a ubiquitous element of modern life. The promotion of merchandise, services and causes comprises a major economic force in daily commerce. A person, group or agency seeking to place an advertisement desires to have the advertisement experienced by individuals and groups most likely to be influenced by the message, whether the intent of the message is to cause the recipient to form an opinion, to purchase an item or experience, to donate to a cause or to act for or against a particular political or cultural action, or to achieve some other result.

To the advertiser, the value of an advertisement is determined by the likelihood that the advertisement will achieve the desired result. A number of factors influence the likelihood, including the nature and quality of the message, the choice of advertisement placement, the nature of the audience for the particular placement scenario, and the circumstances under which the advertisement is experienced. As a simple example, an advertisement seeking to promote the sale of sports equipment is likely to be most effective if broadcast during a sporting event in which the equipment is used; similarly, an advertisement for fishing gear might be most effective if placed in a magazine aimed at outdoor enthusiasts. A desirable feature of a system for incorporating an advertisement in media is to accurately predict the likelihood that the desired audience will be reached by the media and thus by the advertisement.

The art and science of advertisement placement is an important economic endeavor. A complex industry exists in monitoring, measuring and estimating the size and makeup of the audience for various types of popular media. The Nielsen Company is an exemplar in this field; according to their website, “Nielsen measures and analyzes ad effectiveness across TV, Web and Mobile platforms, providing a precise understanding of consumer reach, receptivity, resonance and response.” Nielsen uses specially-equipped hardware to directly measure broadcast television viewership habits, including tuning into and away from specific programs or advertisements. Nielsen also uses indirect survey techniques to gather more generalized information about viewing behavior, such as the self-reported size of the audience for particular programs. The Nielsen and similar audience rating systems record or estimate the behavior of the target audience, but do not measure whether the target audience actually viewed the associated media content, nor the extent to which the media content influenced the target audience. Of course, more complex survey-based methods exist to query audiences as to the effect of media consumption, but such surveys are expensive to undertake and rely on explicit audience cooperation and participation.

In the world of web-based online advertisement, direct measurement of user behavior and response is possible, so that much more comprehensive and detailed response statistics can be obtained. For example, U.S. Pat. No. 7,685,019 describes the use of click-through (response) data captured in a computer environment to evaluate the effectiveness of an advertisement. Once again, however, the behavior data is used to infer the impact of media on the viewer, rather than directly measuring such impact.

Viewer behavior data can be employed in various ways to assign values to particular advertisement scenarios. For example, U.S. Pat. No. 6,286,005 describes a system that generates a score for a proposed advertising schedule based on the measured behavior of viewers in a sample audience viewing broadcast media content. U.S. Pat. No. 6,772,129 (hereafter '129) describes a complex system for determining the effectiveness of an advertisement based on the expected number of impressions, reduction rate, saturation curve, and regression coefficients determined from statistical analysis or experience. The system of '129 relies at least in part on the direct measure of audience behavior (e.g. the purchase or consumption of the advertised product or service), but relating the behavior to other measured or estimated statistical data is done by inference.

A separate but related area of scientific analysis and measurement focuses on quantifying the physical or emotional impact of advertising or media content. For example, U.S. Pat. No. 5,243,517 describes a physiological system utilizing electroencephalographic (EEG) activity as a measure of viewer response to an audio-visual presentation. Similarly, the Nielsen Company uses the capabilities developed by NeuroFocus Inc. to directly measure physiological responses to media content. Direct measures of response are intrusive and depend on the cooperation of the subject. Such measurements of neurophysiological or other bodily responses to media content are indirect in the sense that they measure physical rather than mental or emotional response to content. Of course, physical, mental and emotional impacts of media can all influence a consumer's response to an advertisement.

Social media are becoming an increasingly important and impactful aspect of life. Users' response to social media content and social media interaction is recognized as an important factor influencing behavior and decision making. Various systems and methods have been described in the prior art for determining the impact of social media. For example, U.S. Pat. No. 7,640,304 describes the use of emotional indicia within social media communications to develop a rating for a topic being discussed or reviewed. The system measures the rate of occurrence of specific indicia within the content to infer emotional impact, and treats all content and occurrences as equivalent. Other systems in the prior art utilize social media for evaluating or selecting individuals within a group. For example, U.S. Pat. No. 7,143,054 (hereafter '054) describes a system and method for quantitatively assessing the relative communication strength of the members in a group utilizing electronic messaging. In the system of '054 the mere fact of communication, irrespective of the content of the communication, is used to determine the level of messaging activity; based on the magnitude and directionality of communication links, an individual is selected from the analyzed group of individuals. The system does not assign weights to communication links or perform syntactic or semantic analysis of content. Further by way of example, in U.S. Patent Application 2009/0329539 (hereafter '539), Soza et al. describe a method for evaluating the behavior of a group of members of a social network to determine the influence of a given member on other members in the group, and based upon this determination of influence, selecting a member to receive a promotional offer that the member may subsequently refer to other group members. In the system of '539 the members of the group must have pre-existing relationships, and the determination of the influence of a member is based at least in part on characterizing friends of the member based on the pattern of activity of the friends. These features of the system of '539 preclude its use in anonymous groups.

Another exemplary system that demonstrates the use of social media for quantitative evaluation is described in U.S. Patent Application 2010/0076838 (hereafter '838.) The system of '838 provides a method and system for selecting a celebrity endorser for a product, say an athlete, based on monitoring a plurality of sites for mentions of the endorser in conjunction with positive and negative keywords assumed to reflect the public perception of the athlete as an endorser. The enumeration of mentions is based only on keyword searches within the content of the mention and does not involve syntactic or semantic analysis of the content. Additional measures of popularity such as number of views of YouTube videos may also be incorporated.

A further exemplary system for tracking social media in relation to a specific subject is the website ‘www.socialmention.com’ (accessed on Oct. 11, 2011). This site accepts a string of keywords and searches a database of social media content for the frequency of mention. Several statistical methods are used to derive relative measures of impact. The measures are based solely on the occurrence of the keywords within the content of a social media item. An associated web service accepts structured queries to provide a more flexible interface, but provides the same statistical measures of impact.

Advances in computer hardware and software have greatly influenced the consumption of media content. Computational power, storage capacity, and network speed continue to increase in magnitude and decrease in price. Increasingly with time, the model for distribution of media is moving away from a scheduled “appointment” model where a viewer engages with media at a particular place and time, and toward an unscheduled “demand” model where a viewer has available a vast number of options for experiencing media. For example, the NBC television network broadcasts a regularly-scheduled set of shows. Additionally, NBC makes episodes of these shows available after the scheduled broadcast through their web site and through special-purpose applications on stationary and mobile devices. Since many viewers record broadcast television content for viewing at a later time, the Nielsen Company has developed methods and systems for monitoring the use of personal recorder devices to bolster their survey methods for television viewership. The number of options and the sheer quantity of media content is increasing so quickly that viewers are looking toward secondary sources for recommendations on what and where media are available. For example, Pandora Radio (www.pandora.com, accessed on Oct. 11, 2011) will offer recommendations for music based on stated preferences and personal ratings of previously-presented songs. The Huffington Post (www.huffingtonpost.com, accessed on Oct. 11, 2011) aggregates news and commentary to provide a recommended reading/viewing list for visitors to the site. Consumers often rely on word-of-mouth, or measures of popularity like the “Most Popular” ratings on YouTube, to direct their consumption patterns. Research has shown that recommendations, even by strangers, can have a great impact on the consumption of media (Science 331:854, 2006.) Viewers are more likely to recommend media content to friends or strangers when the media content has a greater emotional impact on them.

None of the systems and methods in the prior art is adequate for capturing the emotional impact of media content. For example, the Nielsen rating system monitors only the viewing of media content, and does not capture the degree of attention paid to the content nor the emotional response invoked by the content. Physiological measurement systems and techniques are complex and intrusive, create an artificial environment in which media is consumed, and measure only indirect responses to media. Prior art systems that purport to measure the impact of media capture only superficial or simplistic information, failing to adequately differentiate between negative, positive and neutral mentions of a piece of media. For instance, an analysis based only on keyword detection would not differentiate between the statements “Episode XYZ was terrific” and “Episode XYZ was anything but terrific.” Furthermore, prior art systems do not adequately quantify the influence of anonymous or stranger recommendations such as on-line reviews or blog postings.

What is desired is a method and system that utilizes social media content to quantify the emotional impact of media content.

### SUMMARY OF THE INVENTION

The present invention provides a method and system for accessing a corpus of social media content, extracting media content ratings from social media content, identifying the authors of the media content ratings, assigning values to the media content ratings, using social media content to assigning relative impact coefficients to the authors of the media content ratings, and using the media rating values and the impact coefficients to quantify the emotional impact of media content.

One aspect of the invention teaches a method and system for providing access to a corpus of social media content; extracting from the corpus of social media content one or more ratings of an item of media content; identifying the author of each of the one or more ratings; analyzing the content of each of the one or more ratings and assigning a value to each of the one or more ratings; analyzing the corpus of social media content and assigning an impact coefficient to the author of each of the one or more ratings; aggregating the values of the one or more ratings, weighted by the assigned impact coefficients of the author of each of the one or more ratings, and determining therefrom an aggregated value; and based on the aggregated value, assigning an emotional impact value to the item of media content.

Another aspect of the invention teaches a data mining engine for use in a media content affinity application. The data mining engine comprises at least one search engine that searches a plurality of social media content for mention of the media content. The data mining engine further comprises a ratings engine that provides for an emotional impact rating of the mention of the media content, where ratings engine includes (i) a syntactic analyzer configured to derive an affinity value from the social media content, and (ii) an author impact analyzer configured to determine an author impact coefficient from an identify of an author of the social media content. The emotional impact rating for the social media content is determined by a weight of the author impact coefficient on the affinity value for the social media content. The data mining engine additionally comprises an emotional impact rating accumulator adapted to receive emotional impact values for a plurality of social media content and determine an aggregated emotional impact value based on the plurality of social media content. A database is configured to associate the aggregated emotional impact value with the media content.

In a further aspect of the inventive method and system, an item of media content comprises text, sound, voice, music, still image, video, or any combination thereof.

In a still further aspect of the invention, social media content comprises one or more of textual, numerical, visual, auditory, or other data.

In a still further aspect of the invention, a value assigned to a rating is based on a singular aspect, feature or characteristic of the item of media content.

In a still further aspect of the invention, a value assigned to a rating is based on two or more attributes, features or characteristics of the item of media content.

In a still further aspect of the invention, a value assigned to a rating is a numerical value, an impact coefficient is a numerical value, and weighting is performed by multiplying a rating value by an impact coefficient.

In a still further aspect of the invention, aggregating values is performed by computing a mean value of the weighted rating values.

In a still further aspect of the invention, assigning an emotional impact value is performed by setting the emotional impact value equal to the aggregated weighted value of the ratings.

In a still further aspect of the invention, an emotional impact value of an item of media content is used to assign a price to or modify the price of purchasing or accessing the item of media content.

### BRIEF DESCRIPTION OF THE DRAWINGS

The preferred and alternative embodiments of the present invention are described in detail below with reference to the following drawings.

FIG. 1 depicts an exemplary embodiment of an aspect of the inventive method and system.

FIG. 2 depicts an exemplary embodiment of an aspect of the inventive method and system.

FIG. 3 depicts an example of social media content.

FIG. 4 depicts an example of social media content.

FIG. 5 depicts an exemplary flowchart depicting an implementation of an aspect of the inventive method and system.

FIG. 6 depicts an exemplary embodiment of an aspect of the inventive method and system.

FIG. 7 depicts an exemplary flowchart depicting an implementation of an aspect of the inventive method and system.

### DETAILED DESCRIPTION OF THE INVENTION

By way of overview, embodiments of the present invention provide a method and system for accessing a corpus of social media content, extracting media content ratings from social media content, identifying the authors of the media content ratings, assigning values to the media content ratings, using social media content to assigning relative impact coefficients to the authors of the media content ratings, and using the media rating values and the impact coefficients to quantify the emotional impact of media content.

In a further embodiment, the inventive method and system provide access to a corpus of social media content; extract from the corpus of social media content one or more ratings of an item of media content; identify the author of each of the one or more ratings; analyze the content of each of the one or more ratings and assign a value to each of the one or more ratings; analyze the corpus of social media content and assign an impact coefficient to the author of each of the one or more ratings; aggregate the values of the one or more ratings, weighted by the assigned impact coefficients of the author of each of the one or more ratings, and determine therefrom an aggregated value; and based on the aggregated value, assign an emotional impact value to the item of media content.

In a still further embodiment of the inventive method and system, an item of media content comprises text, sound, voice, music, still image, video, or any combination thereof.

In a still further embodiment of the inventive method and system, social media content comprises one or more of textual, numerical, visual, auditory, or other data.

In a still further embodiment of the inventive method and system, a value assigned to a rating is based on a singular attribute, feature or characteristic of the item of media content.

In a still further embodiment of the inventive method and system, a value assigned to a rating is based on two or more attributes, features or characteristics of the item of media content.

In a still further embodiment of the inventive method and system, a value assigned to a rating is a numerical value, an impact coefficient is a numerical value, and weighting is performed by multiplying a rating value by an impact coefficient.

In a still further embodiment of the inventive method and system, aggregating values is performed by computing a mean value of the weighted rating values.

In a still further embodiment of the inventive method and system, assigning an emotional impact value is performed by setting the emotional impact value equal to the aggregated weighted value of the ratings.

In a still further embodiment of the inventive method and system, an emotional impact value of an item of media content is used to assign a price to or modify the price of purchasing or accessing the item of media content.

In a still further embodiment of the inventive method and system, an emotional impact value of a first item of media content may be assigned based on an emotional impact value of one or more second items of media content that were created by the creator of the first item of media content, that were directed by the director of the first item of media content, that star or feature a person or persons who star or are featured in the first item of media content, that are episodes of a series which includes the first item of media content, that were written by a person or persons who wrote the first item of media content, that were derived from a work by a person or persons who produced a work from which the first item of media content was derived, or that in another manner were related to the first item of media content.

As used herein, the term “media content” refers to any object or collection of objects and/or data that can be stored and that can engender a repeatable sensory experience. The sensory experience can involve auditory (e.g. music), visual (e.g. paintings or photographs), audio-visual (e.g. movies or television shows), tactile (e.g. sculpture), or other senses alone or in combination.

As used herein, the terms “social media” and “social media content” refer to an instance or a collection of instances of data or objects generated in the context of social interaction by formal, semi-formal or informal means, and distributed to or accessible by the participants of the social interaction. The participants in a social interaction may be known or unknown to one another. An item of social media content may further be accessible to others beyond the immediate participants in the interaction. A social interaction may but need not be mediated by a desktop, laptop, or netbook computer; a tablet computer; a mobile phone, Apple Touch™, Apple iPad™, Android Droid™, or similar mobile device; or any other electronic device. Social media content may incorporate textual, numerical, visual, auditory or other data, or physical objects. A social interaction may involve inter alia an email exchange; a twitter exchange; a twiki posting and comments or responses to the twiki posting; a blog posting and comments or responses to the blog posting; a website posting and comments or responses to the website posting; submissions to a newsgroup; a review posting on a commerce website and comments or responses to the review posting; a video posted to YouTube or other public website and comments or responses to the video posting; and similar on-line activities. A social interaction may include inter alia an exchange of written correspondence, photographs, or printed material. A social interaction may include inter alia the display in a public forum of written, printed, painted or photographic material or the like, and responses to such display in similar form or by other means. The authorship of an item of social media content may be known through direct, indirect or inferential means, or may be unknown. Social media content may but need not be produced in the course of employment, that is, it may be produced as a consequence of professional or of non-professional activity.

As used herein the term “emotional impact” refers to the degree to which an experience engenders an emotional response on the part of an individual undergoing the experience. A positive emotional impact is generally associated with enjoyment and pleasure, while a negative emotion impact is generally associated with abhorrence and disgust. More specifically, a positive emotional impact may but need not be associated with enjoyment and pleasure, but is indicative of a desire to prolong or repeat the associated experience. For example, viewing the climax of a dramatic movie may cause the viewer to weep, but the resulting catharsis may result in a positive emotional impact and a desire to view the movie a second or further time, or to recommend the movie to a friend or acquaintance.

As used herein, the term “rating” applied to an item of media content refers to a written or otherwise recorded expression of an opinion or judgment as to the relative or absolute quality of one or more aspect of the media content. A rating may be quantitative, for example a letter grade from A+ to D−, or a number score on a scale from 1 to 5. Alternatively a rating may be qualitative and may be absolute or relative; for example, content A was good, or content X was better than content Y.

As used herein, the term “value” refers to one of an enumerable set of indicia which have a strict ranking order. The indicia may be absolute or relative. The set of indicia of a value may be binary (for example yes/no or good/bad), ternary (for example positive/neutral/negative), a limited enumerable list (for example, A/B/C/D/E), a numeric value, or otherwise. A numeric value set may consist of a list or range of integer or rational numbers. A numeric value set may be finite or countably infinite. A numeric value set may span strictly positive numbers; strictly negative numbers; strictly non-negative numbers; strictly non-positive numbers; or positive, zero and negative numbers. A value set may have a single dimension, or may have two or more dimensions. In a value set with two or more dimensions, each dimension is assigned a “sub-value”, which refers to a value associated with the particular dimension, and the value set is the collection of all possible combinations of sub-values. A value set with multiple dimensions has a ranking order for each dimension and may have additional ranking orders that apply to combinations of two or more of the dimensions.

As used herein, the term “impact coefficient” refers to a value which expresses the degree to which the statements or actions of one individual are perceived by and influence the statements or actions of another individual. The value of an impact coefficient may be qualitative or quantitative; the value set of an impact coefficient may include positive, negative and neutral indicia.

As used herein, the terms “aggregate” and “aggregating” refer to an algorithmic or heuristic process of combining two or more values to derive a single qualitative or quantitative result.

As used herein, the term “semantic” is intended to refer to the meaning associated with a set of data or symbols. As used herein, the term “syntactic” is intended to refer to the pattern or sequence of words comprising phrases and sentences. A semantic analysis is contrasted with a syntactic analysis, the latter of which is based upon an evaluation of the rules or conventions by which phrases or sentences are constructed. To illustrate, a syntactic analysis of a sequence of words representing English text would involve grouping the words into phrases, the phrases into sentences, and the sentences into paragraphs; by contrast, a semantic analysis of the content would utilize the results of the syntactic analysis to assign linguistic meaning and interpretive weight to the particular sequence of words, phrases, sentences and paragraphs.

The various aspects of the claimed subject matter are now described with reference to the annexed drawings. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. Additionally it should be appreciated that a carrier wave can be employed to carry computer-readable electronic data such as those used in transmitting and receiving electronic mail or in accessing a network such as the Internet or a local area network. Of course, those skilled in the art will recognize many modifications may be made to this configuration without departing from the scope or spirit of the claimed subject matter.

The term “computer” is used herein to refer to any device with processing capability such that it can execute instructions. Those skilled in the art will realize that such processing capabilities are incorporated into many different devices and therefore the term “computer” includes PCs, servers, mobile telephone, tablet computers, personal digital assistants and many other devices.

The methods described herein may be performed by software in machine readable form on a storage medium. The software can be suitable for execution on a parallel processor or a serial processor such that the method steps may be carried out in any suitable order, or simultaneously.

The description acknowledges that software can be a valuable, separately tradable commodity. The description is intended to encompass software, which runs on or controls ‘dumb’ or standard hardware, to carry out the desired functions. It is also intended to encompass software which ‘describes’ or defines the configuration of hardware, such as HDL (hardware description language) software, as is used for designing silicon chips, or for configuring universal programmable chips, to carry out desired functions.

The steps of the methods described herein may be carried out in any suitable order, or simultaneously where appropriate. Aspects of any of the examples described herein may be combined with aspects of any of the other examples described to form further examples without losing the effect sought.

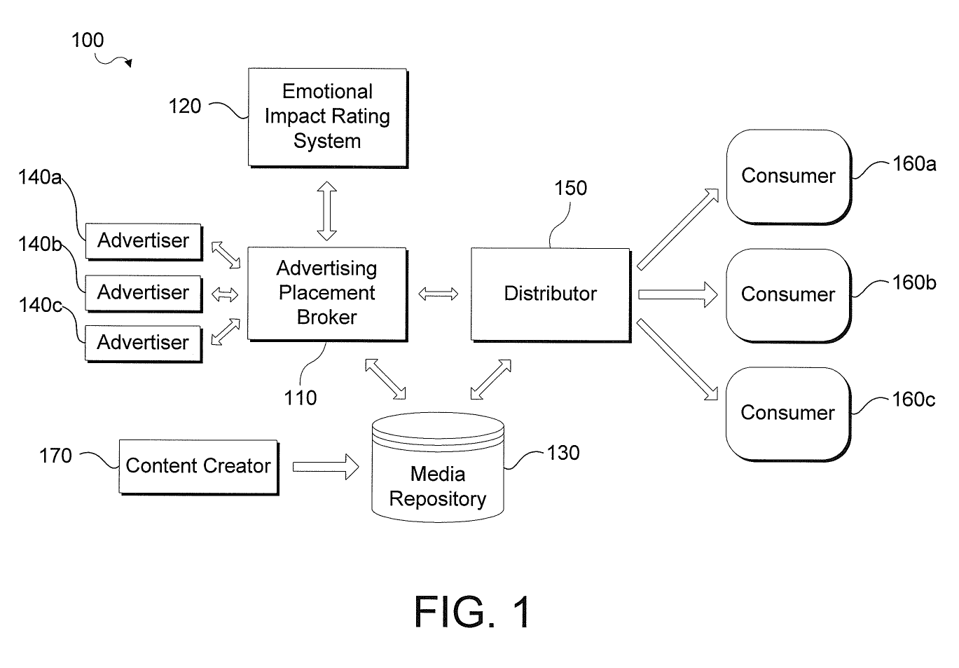

FIG. 1 depicts elements of an exemplary system 100 configured to practice an aspect of the inventive method. In this exemplary system, an advertising placement broker 110 serves to aggregate, sell and fulfill advertisement placement opportunities. Advertisement placement broker 110 receives notification from distributor 150 of an advertisement placement opportunity for an advertisement to be associated and delivered with an item of media content created by content creator 170 and placed in media repository 130. Advertisement placement broker communicates with emotional impact rating system 120 to determine the emotional impact rating of the media content. The emotional impact rating of the media content may be stored in media repository 130 in association with the item of media content. Based at least in part on the emotional impact rating of the media content, advertisement placement broker 110, alone or in conjunction with distributor 150, assigns a price to the advertisement placement opportunity. Advertisement placement broker 110 then offers the advertisement placement opportunity for sale to advertisers 140a, 140b, 140c. The purchasing advertiser delivers payment and advertisement content to advertisement placement broker 110. Advertisement placement broker 110 receives media content from media repository 130, associates the advertisement content with the media content, and provides the combined content to distributor 150 for distribution. Distributor 150 distributes the combined content to one or more consumers 160a, 160b, 160c.

While the foregoing discussion describes an exemplary implementation embodying an aspect of the inventive method, other implementations are possible without departing from the spirit and scope of the inventive method. In an alternative embodiment, the notification of an advertisement placement opportunity may come from media repository 130 or from some other source not shown. The advertisement placement opportunity may be scheduled or unscheduled. More than one advertisement placement opportunity may be associated with a single item of media content. An advertisement placement opportunity may be associated with one or with more than one consumer of an item of media content. An item of media content and associated advertising content may be consumed by one or by more than one consumer. Advertising content may be supplied directly to distributor 150, or may be delivered directly to consumers 160a, 160b, 160c. Aggregation of advertisement content with media content may occur at distributor 150, at the site of the consumer 160a, 160b, 160c, or at another site not shown. Media content may be stored in a media repository 130, may be generated de novo with the advertisement placement opportunity, or may be delivered from some other source not shown. Media content and advertisement content may be tangible and have a persistent physical form, or may be intangible and evanescent. The advertisement placement opportunity may be associated with media content to be broadcast, narrowcast, multicast, unicast, or delivered by some other means to one or more consumers 160a, 160b, 160c of the media content. Distribution of the media content and associated advertisement from distributor 150 to consumers 160a, 160b, 160c may be instantaneous or delayed; may be through physical, electronic, or other means; may be through a wired, wireless, or other network; may be through an underground, surface, atmospheric, space-based or other delivery system; may be through a persistent or ad-hoc network connection; or may be through other means known in the art.

In a further embodiment of an aspect of the current invention, an emotional impact rating system 120 may be used to assign an impact rating value to an item of media content for sale or consumption by a consumer 160a, 160b, 160c directly, without associated advertising content. The item of media content may be produced in advance of the offer for sale or consumption, or may be produced at the time of sale or consumption.

In a further embodiment of an aspect of the current invention, an emotional impact rating may be applied to an item of media content immediately prior to the sale or consumption of the item of media content, or emotional impact ratings may be assigned to one or more items of media content in advance of the sale or consumption of the items of media content. An emotional impact rating may be assigned in a singular process to a single item of media content, or may be assigned in a batch process that assigns ratings to two or more items of media content in a single session.

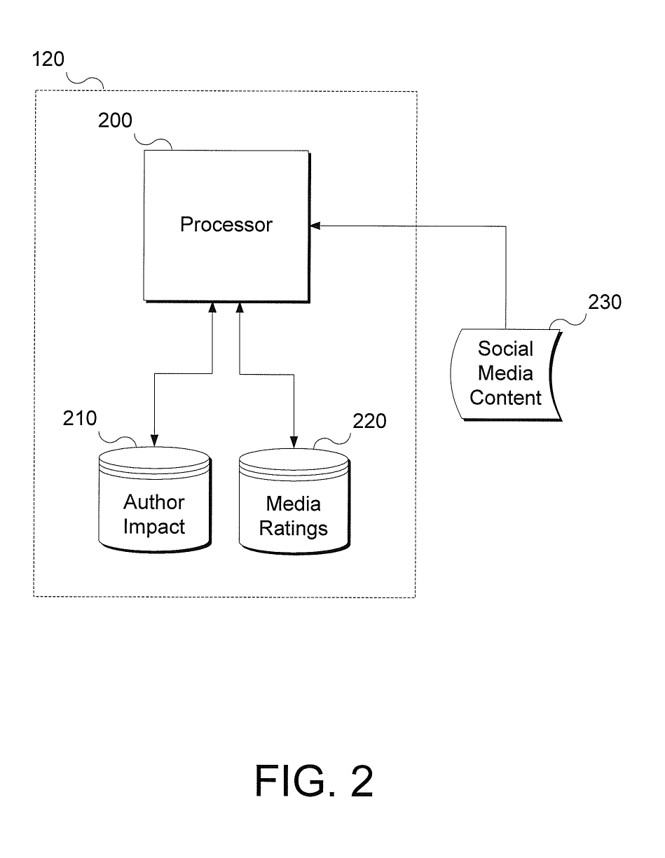

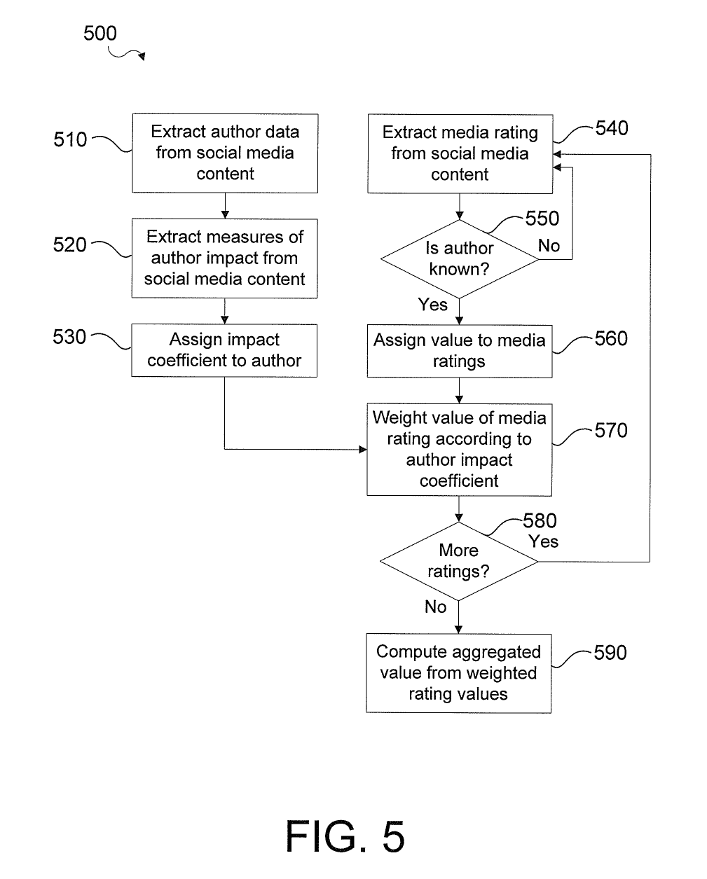

To further illustrate the current invention, FIG. 2 depicts elements of an exemplary implementation of an aspect of the inventive method and system. In this exemplary implementation, emotional impact rating system 120 comprises processor 200 communicatively connected with author impact database 210 and media ratings database 220. When advertisement placement broker 110 or other system requests an emotional impact rating for an item of media content, processor 200 determines if media ratings database 220 contains an emotional impact rating for the item of media content. If so, processor 200 extracts the emotional impact rating from media ratings database 220 and delivers the rating to the requesting system. If not, or if the emotional impact rating in media ratings database 220 is not timely, processor 200 determines an emotional impact rating for the item of media content. Processor 200 retrieves data from social media content source 230, analyses the social media content data, computes values and coefficients, retrieves and/or stores author impact coefficient data in author impact database 210, and determines a final emotional impact rating value for the item of media content, which is delivered to the requesting system and which may be stored in media ratings database 220. The computation of values and coefficients and the determination of a final emotional impact rating are described below in further detail in conjunction with the detailed descriptions of FIGS. 5, 6 and 7. Whereas the foregoing describes emotional impact rating system 120 as a single system, one skilled in the art will recognize that the described functionality of author impact database 210 and of media ratings database 220 may be incorporated into emotional impact rating system 120 or may be provided by a single external database system, by multiple external database systems or by other methods known in the prior art without departing from the spirit and scope of the invention.

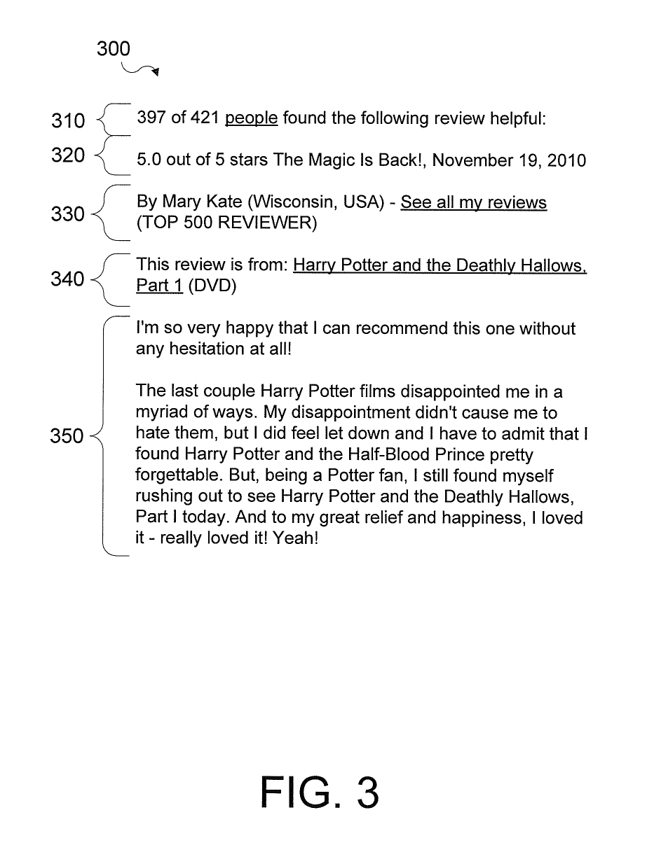

FIG. 3 depicts an exemplary social media content item 300 that may be retrieved by processor 200 from social media content source 230. In social media content item 300, an author has written a review of the movie “Harry Potter and the Deathly Hallows, Part 1.” The review was posted on a commercial web site offering the movie for sale as a DVD or for immediate download and viewing. Social media content item 300 could have been retrieved from social media content source 230 by a general keyword search for the title of the movie, or by a targeted search of reviews posted to one or more commercial or other web sites, or by other means known in the prior art. Processor 200 performs a syntactic and semantic analysis of the content of social media content item 300 to compute various data utilized in the computation of an emotional impact rating value. In this exemplary case, the syntactic and semantic analysis may divide the content of social media content item 300 into a set of elements 310, 320, 330, 340, 350. The identity of the media content item, “Harry Potter and the Deathly Hallows, Part 1”, is extracted from content element 340. The identity of the author, “Mary Kate”, is extracted from content element 330. Determining the author of a specific item of social media content is required in the inventive method and system when the item is used to determine a rating of an item of media content, as will be described in further detail below. Determining the author of a specific item of social media content may not be required in the inventive method and system when the item is used to determine an impact coefficient for an author of a rating of an item of media content, as will be described in further detail below. Content element 320 contains an explicit numerical rating value, which may be utilized when computing the rating of the item. Content element 350 contains the textual content of the review. Methods described in the prior art for performing keyword searches are clearly inadequate in determining the rating which the author expresses for this item of media content—the text contains a mixture of positive (“happy”, “recommend”, “loved”, “really loved”, “happiness”) and negative (“hesitation”, “disappointed”, “disappointment”, “let down”, “forgettable”) words and phrases, but a semantic analysis indicates that the reviewer has a highly favorable opinion of the movie, which is commensurate with the “5.0 out of 5 stars” rating in content element 320. Accordingly, the inventive method and system include a step of performing a syntactic and semantic analysis of an item of social media content when determining a rating of an item of media content.

In addition to utilizing social media content item 300 to derive a rating for the media content item “Harry Potter and the Deathly Hallows, Part 1”, the inventive method and system may also perform an analysis on content item 300 (along with other social media content items) to compute an author impact coefficient. For example, content element 330 contains a link that leads to additional reviews authored by the same author. These additional reviews may be retrieved from social media content source 230 for further analysis by processor 200. The additional reviews need not discuss the specific media content item for which an emotional impact rating is required, but are used in this context to determine the degree to which the author's ratings influence the opinions or behavior of others in the social network, that is to determine the author impact coefficient for this author. For example, content element 310 indicates that 421 people commented on this review, and that 397 of the people had favorable comments on the review. These numbers could be compared with equivalent numbers from similar reviews by other authors to determine the relative rate of commenting on the reviews posted by this author, and the relative rate of favorable (or unfavorable) reception reflected in those comments. This comparison could lead to a relative ranking, rating or valuation of the size of the population influenced by the author, and a relative ranking, rating or valuation of the degree of influence of the author on the influenced population. An impact coefficient may be a positive, neutral or negative value. Note that content element 310 does not identify the people who commented on this review, and the identification of those persons is not required for the use of such data in determining an impact coefficient for an author of a rating.

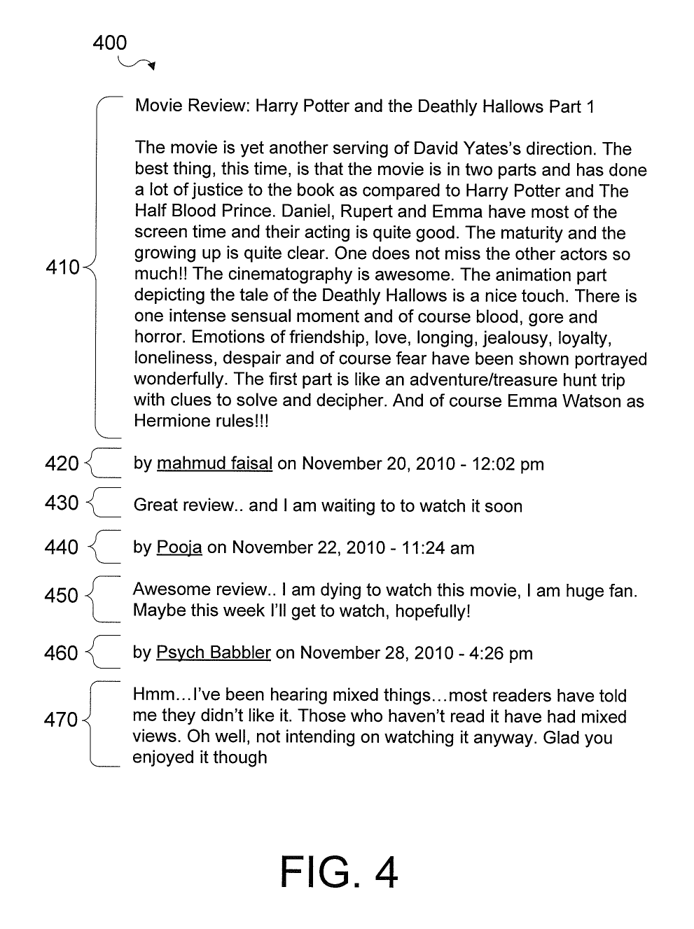

FIG. 4 depicts another exemplary social media content item 400 that may be retrieved by processor 200 from social media content source 230. In social media content item 400, an author has written a review of the movie “Harry Potter and the Deathly Hallows, Part 1.” The review was posted to the author's personal blog site, which allows readers to post responses. Social media content item 400 could have been retrieved from social media content source 230 by a general keyword search for the title of the movie, or by a targeted search of blogs containing movie reviews, or by other means known in the prior art. Processor 200 performs a syntactic and semantic analysis of the content of social media content item 400 to compute various data utilized in the computation of an emotional impact rating value. In this exemplary case, the syntactic and semantic analysis may divide the content of social media content item 400 into a set of elements 410, 420, 430, 440, 450, 460, 470. The identity of the media content item, “Harry Potter and the Deathly Hallow, Part 1” is extracted from the body of the review in content element 410. The social media content item 400 does not explicitly contain the name of the author of the review, but that information can be determined from the context of the blog from which the item was retrieved. A syntactic and semantic analysis of content element 410 is performed to determine the rating associated with the media content item. Additional content elements 420, 430, 440, 450, 460, 470 of social media content item 400 are evaluated in conjunction with the computation of an author impact coefficient for the author of social media content item 400. For example, content element 420 identifies the author ‘mahmud faisal’ of a response to content element 410, and content element 430 contains the response submitted by that author. A syntactic and semantic analysis of content element 430 indicates that the author ‘mahmud faisal’ was positively influenced by the rating of the author of content element 410. Similarly, content element 440 identifies a second author ‘Pooja’ who submitted the response contained in content element 450. Again a syntactic and semantic analysis of content element 450 indicates that the author ‘Pooja’ was positively influenced by the rating of the author of content element 410. A third author ‘Psych Babbler’ identified in content element 460 submitted the response contained in content element 470. In this case, a syntactic and semantic analysis of content element 470 indicates that ‘Psych Babbler’ was not influenced either positively or negatively by the rating of the author of content element 410. The analyses of response content elements 430, 450, 470 can be aggregated with similar response content elements associated with other ratings by the author of content element 410 to determine an author impact coefficient, as will be discussed further below. Whereas in social media content item 400 the responses 430, 450, 470 to the rating 410 are each associated with named authors, for the computation of author impact coefficient the responses or other associated social media data may be anonymous.

Attention is now drawn to FIG. 5 which shows steps of an exemplary implementation 500 of a method in accordance with an aspect of the current invention for assigning an emotional impact value to an item of media content. At a step 510 author impact data are extracted from a body of social media content. Examples of such data have been described above in the discussions of FIG. 3 and FIG. 4. Examples of author impact data include inter alia the number of readers of one or more items written by an author who has provided a rating of the item of media content; the number of responders to one or more items written by an author who has provided a rating of the item of media content; the number of views of one or more videos of an author who has provided a rating of the item of media content; the number of downloads of audio recordings of an author who has provided a rating of the item of media content; and the viewership of a site upon which an author rating is displayed. At a further step 520 such author impact data are analyzed to extract measures of author impact. As a non-limiting example, the average count of the number of readers of items written by an author who has provided a rating of the item of media content may be compared with the average count of the number of readers of items written by other authors in a similar context. As a further non-limiting example, the average count of the number of responders to items written by an author who has provided a rating of the item of media content may be compared with the average count of the number of responders to items written by other authors in a similar context. As yet a further non-limiting example, the count of the number of views of one or more videos of an author who has provided a rating of the item of media content may be compared with the count of the number of views of videos of other authors in a similar context. As yet a further non-limiting example, the total number of downloads of audio recordings of an author who has provided a rating of the item of media content may be compared with the total numbers of downloads of audio recordings of other authors in a similar context. As yet a further non-limiting example, a third-party rating such as the reviewer rank assigned by Amazon.com may be used to derive a measure of author impact, for example by computing the inverse of the reviewer rank.

At a further step 530 the measures of author impact are utilized to assign an impact coefficient to an author who has provided a rating of the item of media content. As a non-limiting example, an impact coefficient may be computed by computing the ratio of the average count of the number of responders to items written by an author divided by the largest average count of the number of responders to items written by an author among all authors in a similar context. That is, an impact coefficient may be computed by computing

$${α}_{i} = \frac{{\overline{r}}_{i}}{{Max}_{j = 1 , N} ( {\overline{r}}_{j} )} \qquad ( 1 )$$

where αᵢ is the impact coefficient assigned to author i, r̅ⱼ is the average number of responders to items written by author j, and the maximum value is taken from the N authors in the given context. According to this non-limiting exemplary linear equation, an impact coefficient has a value greater than 0.0 and less than or equal to 1.0. Other equations could be used to compute an impact coefficient, including non-linear, logarithmic, exponential, power, cumulative probability distribution, or other functions. The range of values of an impact coefficient may be bounded or unbounded, and may encompass negative, positive, or negative and positive values. Alternatively, an impact coefficient may be a qualitative value based on the relative ranking of the author among other authors in a similar context, or on some other criterion applied to author impact data.

Further in exemplary implementation 500, at a step 540 a media rating of the item of media content is extracted from social media content. A media rating may be located within social media content by searching based on keywords, by examining a subset of social media content such as blog sites or commerce sites, or by other means known in the prior art. When a media rating is extracted from social media content, at a further step 550 a determination is made whether the author of the rating is known. If the author of the rating is unknown, the rating is discarded and a step 540 is repeated. If the author of the rating is known, at a further step 560 a syntactic and semantic analysis is performed to determine a value to be assigned to the media rating.

A variety of methods have been described in the prior art for performing syntactic and semantic analysis for the determination of sentiment expression within a body of content. An overview of this field of endeavor is provided by Pang and Lee in “Opinion mining and sentiment analysis” (Foundations and Trends in Information Retrieval, 2008, Vol. 2 Nos. 1-2, pages 1-135). Syntactic analysis could be performed for example by the Stanford Log-linear Part-Of-Speech Tagger (http://nlp.stanford.edu/software/tagger.shtml) described by Toutanova et al. in “Feature-rich part-of-speech tagging with a cyclic dependency network” (Proceedings of HLT-NAACL 2003, pages 252-259). Once an item of social media content has been processed by the part-of-speech tagger, the method of Qiu et al. described in “Opinion word expansion and target extraction through double propagation” (Computational Linguistics, March 2011, Vol. 37 No. 1, pages 9-27) could be applied to use a dependency parser to identify relationships among the constituent words in sentences, then perform double propagation to both expand the lexicon of opinion words and determine the polarity of the sentiment expressed by the content. As an alternative, a body of (human-) annotated social media content could be used to build a domain-specific opinion lexicon using the method described by Cruz et al. in “Automatic expansion of feature-level opinion lexicons” (Proceedings of the 2nd Workshop on Computational Approaches to Subjectivity and Sentiment Analysis, ACL-HLT 2011, pages 135-131); this lexicon can then be utilized as described by Cruz et al. to perform sentiment analysis on additional items of social media content. Each of these methods described in the prior art can be used to determine a sentiment associated with an item of social media content. For example, if a lexicon of opinion words is utilized during the sentiment analysis, each opinion word could be associated with one or more value indicia. If the value were to be based on a binary ranking (for example good/bad), each opinion word in the lexicon could be assigned to one of the two categories; opinion words that could not be assigned to one of the two categories would not be used in the sentiment analysis. If the value were to be based on a set of ranking values, (for example, the set of digits from 0 to 4 inclusive corresponding with least favorable to most favorable value) each opinion word in the lexicon could be associated with one of the ranking values. As noted above, the final result of the semantic analysis would depend not simply upon the presence of a given opinion word but also upon any associated qualifiers or modifiers associated with the opinion word. Pang and Lee provide an overview of prior art systems and techniques used to perform such processing.

Based on the syntactic and semantic analysis, a value is assigned to the rating. The value may be qualitative or quantitative, and may be selected from a finite or countably infinite set of possible values, where the set of possible values has the characteristic that the members of the set can be unambiguously ordered from lowest to highest rank. The assigned value of the item of media content may have one dimension, and may be associated with a single attribute, feature or characteristic of the item of media content; or may have two or more dimensions, each dimension being associated with an attribute, feature or characteristic of the item of media content. In the case that a value is assigned according to two or more attributes, features or characteristics of the item of media content, the sub-value assigned to each attribute, feature or characteristic may be qualitative or quantitative, and may be selected from the same or different finite or countably infinite set of possible sub-values, where each set of possible sub-values has the characteristic that the members of the set can be unambiguously ordered from lowest to highest rank, and further that among the two or more attributes, features or characteristics, the two or more attributes, features or characteristics can be ordered in priority order from least to highest priority, so that the overall value for the two or more attributes, features or characteristics can be unambiguously placed in a rank order from lowest to highest rank. The ranking of two or more attributes, features or characteristics may be based on more than one ranking rule. As an alternative, the values of the two or more attributes, features or characteristics may be combined according to an algorithm using a linear or non-linear formula or other heuristic to compute a final value or assign a final rank order.

To further illustrate, suppose that the media content is an episode of a television show, and that a value is to be assigned to each rating based on the overall quality of the experience of the media content. The value may be taken from a list of values including ‘hated’, ‘disliked’, ‘neutral’, ‘liked’ and ‘loved’, the list being in rank order from lowest to highest value. Alternatively, the value could be assigned a rational numerical value in the range from 0.0 to 5.0 inclusive, the value of 0 being the lowest and the value of 5 being the highest. This exemplifies the case where the value is based on a single attribute of the media content.

As a yet further illustration, suppose that the media content is a movie and that sub-values are to be assigned to each rating based on the excitement engendered by the movie and the empathy felt for the starring character of the movie. The value for excitement could be determined by performing sentiment analysis as described above using a lexicon of words related to the concept of excitement, and the value for empathy could be separately determined by performing sentiment analysis as described above using a separate lexicon of words related to the concept of empathy. The excitement may be assigned an integer numerical sub-value in the range from 1 to 10 inclusive, and the empathy may be assigned a sub-value from a list of sub-values including ‘disgusted by’, ‘annoyed by’, ‘no feeling’, ‘sympathized with’ and ‘strongly associated with’, with the list being in rank order from lowest to highest value. In this case, the empathy sub-value may be chosen as the higher priority and the excitement sub-value may be chosen as the lower priority. A syntactic and semantic analysis of the content may determine a rating sub-value for both attributes of the movie, or may determine a rating sub-value for only one or the other of the attributes. In the case where only one of the attributes is assigned a sub-value, the other attribute may be assigned a nominal, median or neutral value. In this exemplary case, if a rating provides an excitement sub-value but no empathy sub-value, the empathy sub-value may be assigned the ‘no feeling’ sub-value from the set of sub-values, indicating the median sub-value. The ‘no-rating’ sub-value may be an extremum or non-extremum sub-value among the set of sub-values.

Further in exemplary implementation 500, at a step 570 the assigned value is weighted according to the impact coefficient of the author of the rating. Accordingly, steps 510, 520, 530 of exemplary implementation 500 are repeated as required to determine an impact coefficient for each unique author of a rating extracted from social media content at a step 540. The method used to weight an assigned value may be determined by the nature of the assigned rating value and of the impact coefficient of the author of the associated rating. As a non-limiting example, if the assigned value determined at a step 560 is a numerical value and the impact coefficient assigned at a step 530 is a numerical value, the weighting may be performed by computing the product of the assigned value and the impact coefficient. That is, if the assigned value of the i-th rating written by author k is βᵢ^{k} and the impact coefficient of author k is αₖ then the weighted value of the i-th rating may be computed as αₖβᵢ^{k}. As a further non-limiting example, if the impact coefficient is a qualitative value, the weighting may be performed by assigning a sorting order to the assigned rating value based on the impact coefficient, so that assigned rating values with the lowest-ranked impact coefficient are placed in lower rank order than assigned rating values with the highest-ranked impact coefficient. As yet a further example, if the impact coefficient is an integer value and the assigned rating value is a qualitative value, the assigned rating value may be replicated the number of times indicated by the impact coefficient prior to determining the aggregated value. In a particular implementation of the inventive method and system an impact coefficient may be assigned from a value set that includes both positive and negative values; if the rating values in this implementation also include both positive and negative values, the resulting weighted value of a rating value may be positive even if the rating value is negative, since the author of that rating may have a negative impact on others who are exposed to the rating. Another way of expressing this is to observe that if a reviewer always gives ratings that are markedly different than the average ratings, but readers of those reviews recognize this tendency in the reviewer, the result of a negative review by the reviewer might be to encourage readers to experience the media content being reviewed, in the expectation that their experience will be different from that described by the reviewer and will therefore be positive.

Further in exemplary implementation 500, at a step 580 a determination is made whether further ratings are required. As a non-limiting example, the determination may be made by counting the number of weighted rating values that have been accumulated. If the determination indicates that further ratings are required, control returns to a step 540. If the determination indicates that further ratings are not required, at a step 590 an aggregated value is computed from the weighted rating values. In this exemplary implementation, the aggregated value is the emotional impact value for the item of media content. As a non-limiting example, the aggregated value may be computed as a weighted mean of the accumulated weighted rating values, that is, for a set of N ratings of media content item j written by a set of N different authors, the emotional impact value Eⱼ may be computed as

$${E}_{j} = \frac{{\sum }_{i = 1}^{N} {α}_{i} {β}_{j}^{i}}{{\sum }_{i = 1}^{N} {α}_{i}} . \qquad ( 2 )$$

As an alternative, the aggregated value may be computed by sorting the weighted rating values in rank order, then computing a mean, median, mode, or other statistical measure of the distribution of ranked values. Other alternative methods of computing an aggregated value from a set of weighted rating values, which will be obvious to one skilled in the art, may be used without departing from the spirit and scope of the invention.

An exemplary calculation of an aggregated emotional impact value according to one embodiment is shown with reference to Table 1, below:

TABLE 1
Emotional Impact Value for Media Content ‘X’

| Author/ | Author Impact | | |
|---|---|---|---|
| Reviewer | Coefficient (αₖ) | Media Rating | Emotional Impact (k) |
| 1 | 1.0 | −1.0 | −1.0 |
| 2 | 0.25 | 0.25 | 0.0625 |
| 3 | 0.01 | 1 | 0.01 |
| 4 | 0.5 | 0 | 0 |
| 5 | 0.9 | −0.25 | −0.225 |
| TOTAL | 2.66 | | −1.1525 |

AGGREGATED EMOTIONAL IMPACT VALUE = −1.1525/2.66 = −0.433

Table 1 assumes a letter grade given to the media content can be associated with a numeric value—here a strongly positive review such as an A rating is assigned a media rating value of 1.0, a generally positive review such as a B rating is assigned a value of 0.5, a neutral C rating a value of 0, a negative review or D rating a value of −0.5, and a strongly negative review such as an F a −1.0 score. The results in Table 1 illustrate the affect that an author impact coefficient can have on the accumulated emotional impact value. The media rating value or affinity that the five reviewers have given are equally distributed, which when averaged would result in a neutral 0 score. However, the final aggregated score has a distinctly negative affinity of −0.433 or near a D rating due to the affect that the author impact coefficient has in influencing the aggregated score. That is, the −1.0 rating given by influential author ‘1’ (author impact coefficient 1.0) far offsets the equally positive rating given by a much less influential author ‘3’ (author impact coefficient 0.01).

The foregoing discussion of FIG. 5 applies directly to an item of media content for which ratings have been produced by one or more authors. In an alternative embodiment of an aspect of the inventive system, an emotional impact value may be determined for a new item of media content prior to the first consumption of the item. In this alternative embodiment, an emotional impact value may be determined for one or more items of media content that are related to the new item of media content, and an emotional impact value may be determined for the new item of media content based on the emotional impact values for the related items of media content. For example, if a new item of media content is a new episode in a series of episodes, an emotional impact value may be determined for one or more previous episodes in the series of episodes, and an emotional impact value may be assigned to the new episode based on the emotional impact values of the one or more previous episodes. As a further example, if a new item of media content stars or features a person or persons who starred or were featured in one or more prior items of media content, emotional impact values may be determined for the one or more prior items of media content, and the emotional impact values for the one or more prior items of media content may be used to assign an emotional impact value to the new item of media content. As yet a further example, a new item of media content may be a sporting event involving two teams, and emotional impact values may be determined for one or more prior sporting events involving one or both of the involved teams, and the emotional impact values of the prior sporting events may be used to assign an emotional impact value to the new sporting event. As yet further examples, one or more items of media content that are related to a new item of media content may be selected and assigned emotional impact values, where the relationship is based on having a common writer, director, producer, cinematographer, subject matter, or other common feature. In this alternative embodiment, the emotional impact values of prior items of media content may be combined using an algorithm or heuristic method to obtain an emotional impact value for a new item of media content. For example, an average of the prior emotional impact values may be computed to obtain the new emotional impact value. As a further example, the new emotional impact value may be extrapolated from the temporal progression of emotional impact values of prior items of media content, for instance by examining the sequence of emotional impact values of prior sporting events involving one or both of the players or teams involved in a new sporting event.

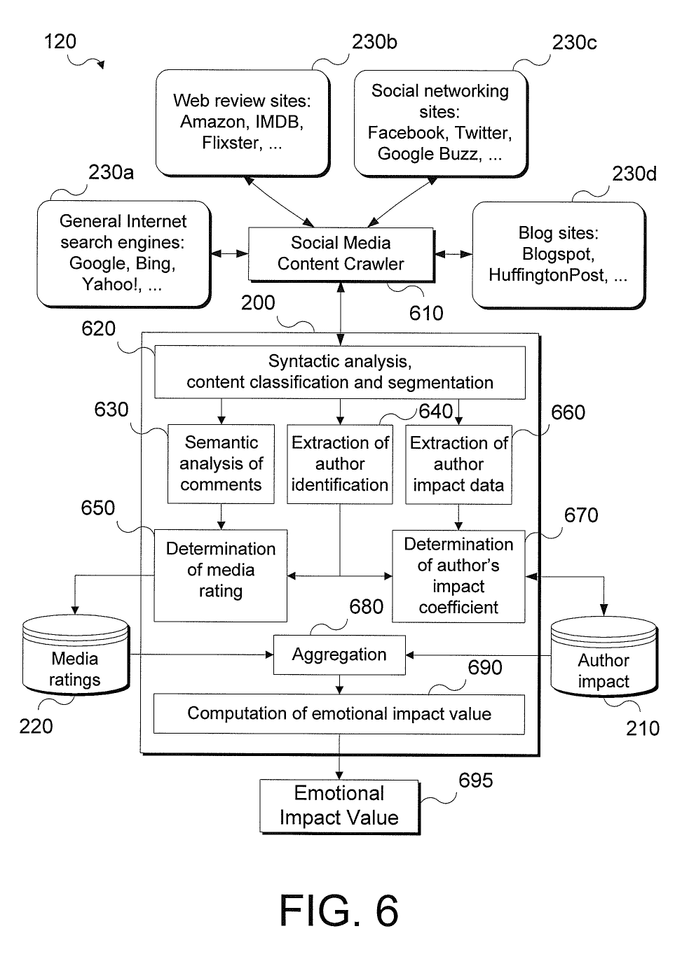

Attention is now drawn to FIG. 6, which shows components of an exemplary implementation of an emotional impact rating system 120 in accordance with an aspect of the current invention for assigning an emotional impact value to an item of media content. The components of the system depicted in FIG. 6 may be used for example to implement the steps of the method depicted in FIG. 5. A processor 200 implements a set of sub-processes 620, 630, 640, 650, 660, 670, 680, 690 for the purpose of assigning an emotional impact value to an item of media content.

A social media content crawler 610 communicates through standard web interfaces known in the art to one or more sources of social media content, including inter alia general internet search engines 230a, web review sites 230b, social networking sites 230c, and blog sites 230d, to gather social media content relevant to a particular item of media content and to gather social media content relevant to authors of social media content relevant to a particular item of media content. Extraction of social media content may be by means of generalized web searches, by targeted web searches, by use of a public application programming interface (API), by ‘scraping’ of website content, and/or by other means known in the prior art.

Social media content crawler 610 may be implemented as a sub-process on processor 200, may be implemented on a separate processor (not shown), or may be implemented partly on processor 200 and partly on a separate processor. Social media content crawler 610 aggregates social media content source material comprising media ratings gathered from social media content sources 230a, 230b, 230c, 230d, and others. Social media content crawler 610 supplies the social media content source material and associated metadata such as the origin of the source material to sub-process 620 which performs initial syntactic analysis on the social media content source material.

Analysis sub-process 620 analyzes the overall structure and content of the source material, segments the source material into relevant fragments, and provides the fragments to further sub-processes 630, 640, 660. For example, by reference to FIG. 3 analysis sub-process 620 may segment an item of social media content 300 into fragments 310, 320, 330, 340, 350.

Semantic analysis sub-process 630 performs a semantic analysis on the content of the fragment describing the author's review, analysis or opinion of the item of media content using the method described in the foregoing discussion of FIG. 5. For example, by reference to FIG. 3 semantic analysis sub-process 630 may perform a semantic analysis on fragment 350 of social media content item 300.

Extraction sub-process 640 determines the identity of the author from relevant content fragments or from metadata associated with the social media content. For example, by reference to FIG. 3 extraction sub-process 640 may determine the identity of the author of social media content item 300 by analyzing fragment 330. The output of sub-processes 630 and 640 are fed to determination sub-process 650 which computes a media rating for the item of social media content using the method described in the foregoing discussion of FIG. 5. The author identity and the media rating are stored in media ratings database 220.

Extraction sub-process 660 extracts author impact data from relevant content fragments, for example using the method described in the foregoing discussion of FIG. 5. For example, by reference to FIG. 3, extraction sub-process 660 may utilize fragment 310 of social media content item 300 to extract author impact data.

The outputs of sub-processes 640 and 660 are fed to author impact analyzer 670 which computes an author impact coefficient using the method described in the foregoing discussion of FIG. 5. The author identity and the author impact coefficient are stored in author impact database 210. Once a sufficient quantity of media ratings data and author impact data have been accumulated, aggregation sub-process 680 extracts media rating data relevant to an item of media content, with associated author data, from media ratings database 220, extracts corresponding author impact coefficient data from author impact database 210, and passes this aggregated data to computation sub-process 690.

Computation sub-process 690 computes an emotional impact value 695 using the method described above in the discussion of FIG. 5. The sub-processes depicted in FIG. 6 and described above may be performed by a single processor at a single site or by multiple processors at multiple sites, and may be performed in the sequence shown, in other sequences not shown, serially, in parallel, or in other combinations, without departing from the spirit and scope of the invention.

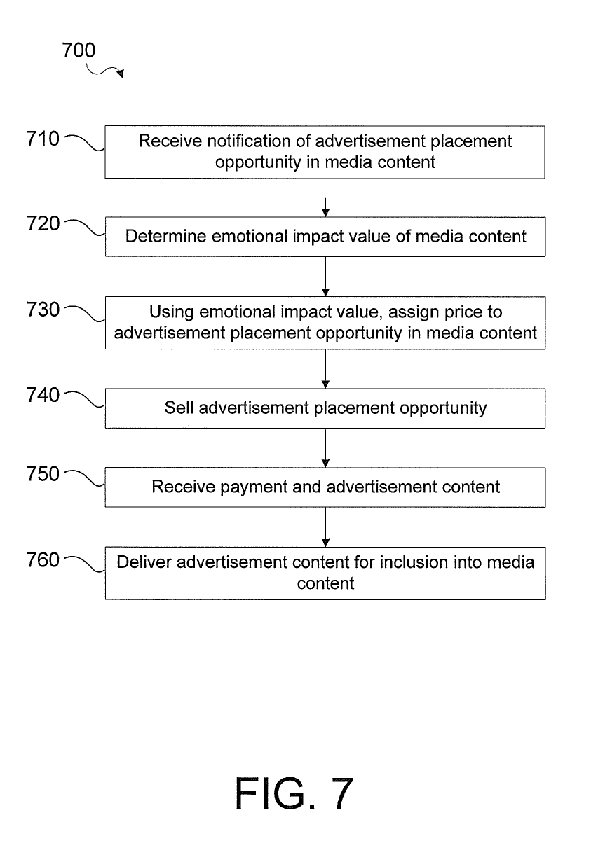

Once an emotional impact value has been assigned to an item of media content, the emotional impact value may be used for various commercial and non-commercial purposes. For example, a vendor of the item of media content may wish to reference the emotional impact value directly or indirectly when advertising the availability of the item of media content for rental or sale. As a further example, the vendor of the item of media content may wish to utilize the emotional impact value when setting a price for the rental or sale of the item of media content, or setting a price for the opportunity to place an advertisement at an interstitial interval within the item of media content. A still further exemplary use of an emotional impact value is shown in FIG. 7, which depicts a set of steps of an exemplary process 700 for practicing an aspect of the current invention. In exemplary system 100 shown in FIG. 1, advertising placement broker 110 negotiates and manages the sale and fulfillment of advertisement placement opportunities. In accordance with an aspect of the current inventive method, at a step 710 advertisement placement broker 110 receives notification of an advertisement placement opportunity in media content. At a step 720 advertisement placement broker 110 determines an emotional impact value for the item of media content. The determination of an emotional impact value may be made at the time of notification, or may have been made at an earlier time with an emotional impact value being stored for later retrieval. Alternatively, if a determination of emotional impact value had previously been made and stored but the delay between a determination of emotional impact value and the notification of the advertisement placement opportunity exceeds a maximum duration threshold, advertisement placement broker 110 may make a new determination of emotional impact value for the item of media content. At a further step 730, advertisement placement broker 110 utilizes an emotional impact value determined at a step 720 to assign a price to the advertisement placement opportunity. For example, if an emotional impact value of the item of media content is high, advertisement placement broker 110 may assign a high price to the advertisement placement opportunity, while if an emotional impact value of the item of media content is low, advertisement placement broker 110 may assign a low price to the advertisement placement opportunity. At a further step 740, advertisement placement broker 110 makes the advertisement placement opportunity available for sale at the assigned price and sells the advertisement placement opportunity. At a further step 750, advertisement placement broker 110 receives payment for the advertisement placement and advertisement content to be placed into the advertisement placement opportunity. At a further step 760, advertisement placement broker 110 delivers advertisement content for inclusion into media content.

In the foregoing discussion of FIG. 7, all steps are performed by a single agent. In an alternative embodiment of exemplary process 700, steps may be performed by two or more agents and in other sequences. For example, the determination of the emotional impact value may be performed by emotional rating system 120 operated by an entity other than the agent requesting the emotional rating value. As a further example, receipt 750 of advertisement content may be made by an agent other than the agent selling the advertisement placement opportunity, and delivery of advertising content 760 for inclusion in media content may be performed by an agent other than the agent selling the advertisement placement opportunity. Delivery of payment may be delayed relative to the delivery of advertisement content. The steps of exemplary process 700 may be performed by a single system at a single site or by multiple systems at multiple sites, and may be performed in the sequence shown, in other sequences not shown, serially, in parallel, or in other combinations, without departing from the spirit and scope of the invention.

While preferred embodiments of the invention have been illustrated and described, as noted above, many changes can be made without departing from the spirit and scope of the invention. Accordingly, the scope of the invention is not limited by the disclosure of a preferred embodiment. Instead, the invention should be determined entirely by reference to the claims that follow.

What is claimed is:

1. In a computer system, a method of assigning an emotional impact value to an item of media content characterized by:
providing access to a corpus of social media content;
extracting from the corpus of social media content one or more ratings of the item of media content;
identifying the author of each of the one or more ratings;
analyzing the content of each of the one or more ratings and assigning a value to each of the one or more ratings;
analyzing the corpus of social media content and assigning an impact coefficient to the author of each of the one or more ratings;
aggregating the values of the one or more ratings, weighted by the assigned impact coefficient of the author of each of the one or more ratings, and determining an aggregated value; and
based on the aggregated value, assigning an emotional impact value to the item of media content.

2. The method of claim 1, wherein an item of media content comprises text, sound, voice, music, still image, video, or any combination thereof.

3. The method of claim 1, wherein social media content comprises one or more of textual, numerical, visual, auditory, or other data.

4. The method of claim 1, wherein the value assigned to a rating is based on a singular attribute, feature or characteristic of the item of media content.

5. The method of claim 1, wherein the value assigned to a rating is based on two or more attributes, features or characteristics of the item of media content.

6. The method of claim 1, wherein a value assigned to a rating is a numerical value, an impact coefficient is a numerical value, and weighting is performed by multiplying a rating value by an impact coefficient.

7. The method of claim 1, wherein aggregating values is performed by computing a mean value of the weighted rating values.

8. The method of claim 1, wherein assigning an emotional impact value is performed by setting the emotional impact value equal to the aggregated weighted value of the ratings.

9. A data mining engine for use in a media content affinity application, comprising:
at least one search engine that searches a plurality of social media content for mention of the media content;
a ratings engine that provides for an emotional impact rating of the mention of the media content, said ratings engine including:
a syntactic analyzer configured to derive an affinity value from the social media content, and
an author impact analyzer configured to determine an author impact coefficient from an identify of an author of the social media content, wherein the emotional impact rating for the social media content is determined by a weight of the author impact coefficient on the affinity value for the social media content;
an emotional impact rating accumulator adapted to receive emotional impact values for a plurality of social media content and determine an aggregated emotional impact value based on the plurality of social media content; and
a database configured to associate the aggregated emotional impact value with the media content.

10. The data mining engine of claim 9, wherein the author impact coefficient depends upon at least one of the size of a population influenced and a degree of influence on the population influenced.

11. The data mining engine of claim 9, wherein the author impact coefficient depends upon at least one of a number of readers of one or more items written by the author, a number of responders to the one or more items written by the author, a number of views of one or more videos of the author, a number of downloads of audio recordings of the author, and a viewership of a site upon which an author rating is displayed.

12. The data mining engine of claim 11, wherein the author impact coefficient depends upon an average count of a first number of readers of items written by the author compared with an average count of a second number of readers of items written by other authors.

13. The data mining engine of claim 11, wherein the author impact coefficient depends upon an average count of a first number of responders to items written by the author compared with an average count of a second number of responders to items written by other authors.

14. The data mining engine of claim 9, wherein the author impact coefficient is determined by computing
$${α}_{i} = \frac{{\overline{r}}_{i}}{{Max}_{j = 1 , N} ( {\overline{r}}_{j} )}$$
where αᵢ is the impact coefficient assigned to author i, r̅ⱼ is an average number of responders to items written by author j, and a maximum value is taken from the N authors in the given context.

15. The data mining engine of claim 9, wherein the author impact coefficient is a qualitative value based on the relative ranking of the author among other authors in a similar context.

16. The data mining engine of claim 9 wherein the impact coefficient is taken from a value set that includes both positive and negative values.

17. The system of claim 9, wherein the aggregated emotional impact value is further configured to aggregate weighted rating values by computing a mean value of the weighted rating values.
